(19) United States
(12) Patent Application Publication
(10) Pub. No.: US 2004/0044422 A1
(43) Pub. Date: Mar. 4, 2004

(54) System and method for intelligent text input

(76) Inventors: Vadim Fux, Waterloo (CA); Arie V. Mazur, Waterloo (CA)

Correspondence Address: JOSEPH M. SAUER, JONES DAY REAVIS & POGUE, NORTH POINT, 901 LAKESIDE AVENUE, CLEVELAND, OH, 44114, US

(21) Appl. No.: 10/611,519

(22) Filed: Jul. 1, 2003

Related U.S. Application Data
(60) Provisional application No. 60/393,949, filed on Jul. 3, 2002.
(60) Provisional application No. 60/400,752, filed on Aug. 1, 2002.

(51) Int. Cl. G05B 11/01; G05B 15/00

(52) U.S. Cl. 700/17; 700/23; 700/83

(57) ABSTRACT

In accordance with the teaching described herein, systems and methods are provided for intelligent text input. A plurality of text input components may be used to receive text input events from an input device. A text input directing engine may be used to translate a text input event into a platform-independent event. The platform-independent event may include an index value that represents the text input event. A plurality of input methods may be used, with each input method being operable to receive the platform-independent event from the text input directing engine and translate the platform-independent event into one or more input method specific characters based on the index value. The one or more input method specific characters may be displayed on a graphical user interface by one of the text input components.

### CROSS-REFERENCE TO RELATED APPLICATION

This application claims priority from and is related to the following prior applications: “System for Intelligent Text Input,” U.S. Provisional Application No. 60/393,949, filed Jul. 3, 2002; and “Text Input,” U.S. Provisional Application No. 60/400,752, filed Aug. 1, 2002. These prior applications, including the entire written descriptions and drawing figures, are hereby incorporated into the present application by reference.

### FIELD

The technology described in this patent document relates generally to computer text input. More specifically, this document describes a system and method for intelligent text input that is particularly well-suited for use in wireless two-way messaging devices, cellular telephones, personal digital assistants (PDAs), or other types of mobile devices, but that may also have utility in other devices, such as a set-top box or video conference equipment.

### BACKGROUND

The growing use of mobile devices challenges developers and manufacturers to create products that maximize device resources without significantly limiting device performance. One key element in the efficient design of a mobile device is the user interface, which typically includes one or more input components for entering text. However, typical text input components suffer from efficiency concerns, especially when dealing with the limited resources of a mobile device or when text in input in multiple languages.

### SUMMARY

In accordance with the teachings described herein, systems and methods are provided for intelligent text input. A plurality of text input components may be used to receive text input events from an input device. A text input directing engine may be used to translate a text input event into a platform-independent event. The platform-independent event may include an index value that represents the text input event. A plurality of input methods may be used, with each input method being operable to receive the platform-independent event from the text input directing engine and translate the platform-independent event into one or more input method specific characters based on the index value. The one or more characters generated by the input method(s) may be displayed on a graphical user interface by one of the text input components.

### BRIEF DESCRIPTION OF THE DRAWINGS

FIG. 1 is a block diagram of an example system for intelligent text input from a plurality of text input components;

FIG. 2 is a block diagram illustrating an example text input directing engine;

FIG. 3 is a top-view of an example mobile device having a telephone-style keypad for inputting text;

FIG. 4 is a top-view of an example mobile device having a reduced QWERTY-style keyboard for inputting text;

FIG. 5 is a top-view of an example mobile device having a touch screen for inputting text;

FIG. 6 is a block diagram of an example text input-directing engine having loading and unloading mechanisms;

FIG. 7 is a block diagram of an example system for intelligent text input having an application specific text input component; and

FIG. 8 illustrates example application specific text input components for an electronic messaging application.

### DETAILED DESCRIPTION

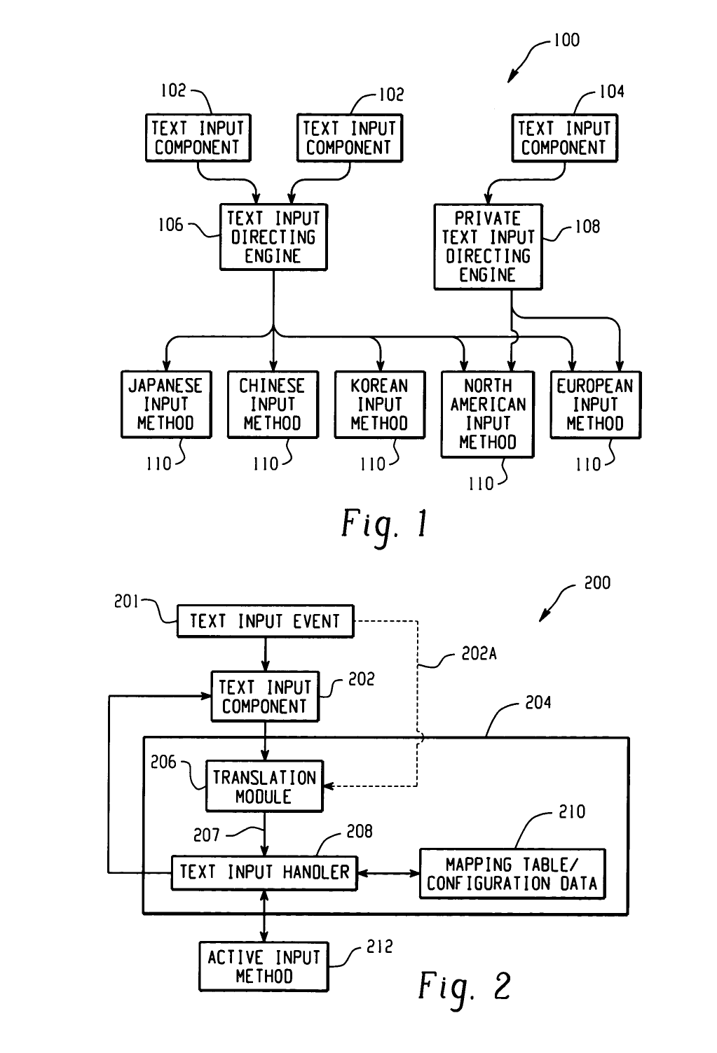

With reference now to the drawing figures, FIG. 1 is a block diagram of an example system 100 for intelligent text input from a plurality of text input components 102, 104. The system 100 includes the plurality of text input components 102, 104, a text input directing engine 106, and a plurality of input methods 110. Operationally, the system 100 provides an application programming interface (API) between the input methods 110 and the text input components 102, 104, such that both may be maintained and operated independently.

The text input components 102, 104 are fields in a user interface that accept and display input from one or more user input device, such as a miniature keyboard, a telephone-type keypad, a virtual keyboard appearing on a touch screen or touchpad, or other input devices. For example, in an electronic messaging application, examples of text input components 102, 104 may include the recipient (“TO”) field, the copy (“CC”) field and the message text field. (See, e.g., FIG. 8).

The text input directing engine 106 converts text input events from the text input components 102 into platform-independent events, and directs the platform independent events to an active input method 110. The text input directing engine 106 may, for example, translate a text input event into an index value, and encapsulate the index value into a platform-independent event along with additional event data, such as the time that the text input event occurred, the number of times that the text input event was repeated, the type of input device, the state of the input device (e.g., shift or alt keys depressed), or other relevant event information. For instance, if a user depresses a key to enter a character into a text input component 102, then the text input directing engine 106 may translate this text input event into an index value corresponding to the particular key depressed. In addition, the text input directing engine 106 may indicate that the particular key was depressed repeatedly or held for a certain amount of time and may also indicate the time at which the key was depressed. The operation of an example text input directing engine 106 is described in more detail below with reference to FIG. 2.

The input methods 110 may map the platform-independent events to particular characters or sets of characters. For example, the input methods 110 may each map different language characters to the same platform-independent event. A particular input method 110 may thus be activated by a device user based on a desired language for the text displayed by the text input component 102. For example, one of the input methods 110 may be defined as the active input method for a particular text input component based on user input or based on the last active input method used. In addition, an input method(s) 110 may apply input logic or other functions to the characters or sets of characters, and may produce the resulting text, along with any variants, to the text input component 102 for display.

Also illustrated in FIG. 1 is a private text input directing engine 108, which may be used by a text input component 104 that is independent of other text input components 102. For example, an independent text input component 104 may require text to be entered in a different language or in another format than other text input components 102. In the case of an electronic messaging application, for instance, the recipient (“TO”) field may be an independent text input component 102 requiring text to be entered using an English language input method 110, while other text input components, such as the message text field, may utilize a different input method 110.

FIG. 2 is a block diagram 200 illustrating an example text input directing engine 204. FIG. 2 illustrates a text input event 201 that is entered into a text input component 202 and received by the text input directing engine 204. Alternatively, the text input event 201 may bypass 202A the text input component 202, for example if the text input component 202 is not in focus, and may be directed from an input device directly to the text input directing engine 204. The text input directing engine 204 includes a translation module 206, a text input handler 208, and a memory location 210 having a mapping table or other configuration data.

The translation module 206 converts the text input event 201 into a platform-independent event. As noted above, the platform-independent event generated by the translation module 206 may include an index value corresponding to the particular text input event 201 along with additional event data, such as the time that the text input event occurred, the number of times the text input event was repeated, or other relevant event information. In addition, the system 200 is preferably adaptable to different types of input devices, such as a keyboard, telephone-type keypad, touch screen, or others. Therefore, the translation module 206 may also identify the type of input device and may include device-specific information in the platform-independent event, such as an identification of the input device and the state of the input device (e.g., normal key layout, shift key layout, control key layout, etc.).

The platform-independent event generated by the translation module 206 is received by the text input handler 208. The text input handler 208 accesses a mapping table 210 or other stored configuration data to associate the platform-independent event with a particular character or set of characters. For example, the text input directing engine 204 may include mapping tables 210 specific to each available input method and type of input device. The text input handler 208 may select the applicable mapping table 210 for a particular platform-independent event based on the currently active input method 212 for the text input component 202 and also based on the type of input device used to create the text input event 201. In this manner, simultaneous inputs may be received and processed from different types of input devices. Moreover, the mapping table 210 or other configuration data may be stored in an editable format, enabling input device configurations to be easily added or modified.

Upon converting the platform-independent event into one or more corresponding characters, the text input handler 208 accesses the active input method 212 to apply input logic or other functions associated with the particular input method 212. For example, in one embodiment, the active input method may have access to a store of linguistic data that may be used to predict additional characters that are likely be associated with the text input event 201. For instance, the active input method 212 may access a word list, such as an address book, to predict a complete word or phrase from a partial word or phrase entered into the text input component 202. In addition, the input method 212 may provide for state-full text input by remembering the current and previous state(s) of the text input. The text input handler 208 then produces the resulting characters, along with any variants, to the text input component 202 for display.

In one embodiment, the mapping table 210 or other configuration data may be included as part of the active input method 212, as described above with reference to FIG. 1. In this case, each input method 110 may include a language specific mapping table 210 or other type of configuration data, or alternatively each input method 110 may access a common store of mapping tables 210 or other configuration data. The active input method 212 may then be accessed by the text input handler 208 to both translate the platform-independent event into one or more corresponding characters using the mapping table 210 and to apply any language or input method specific logic to the resultant textual data.

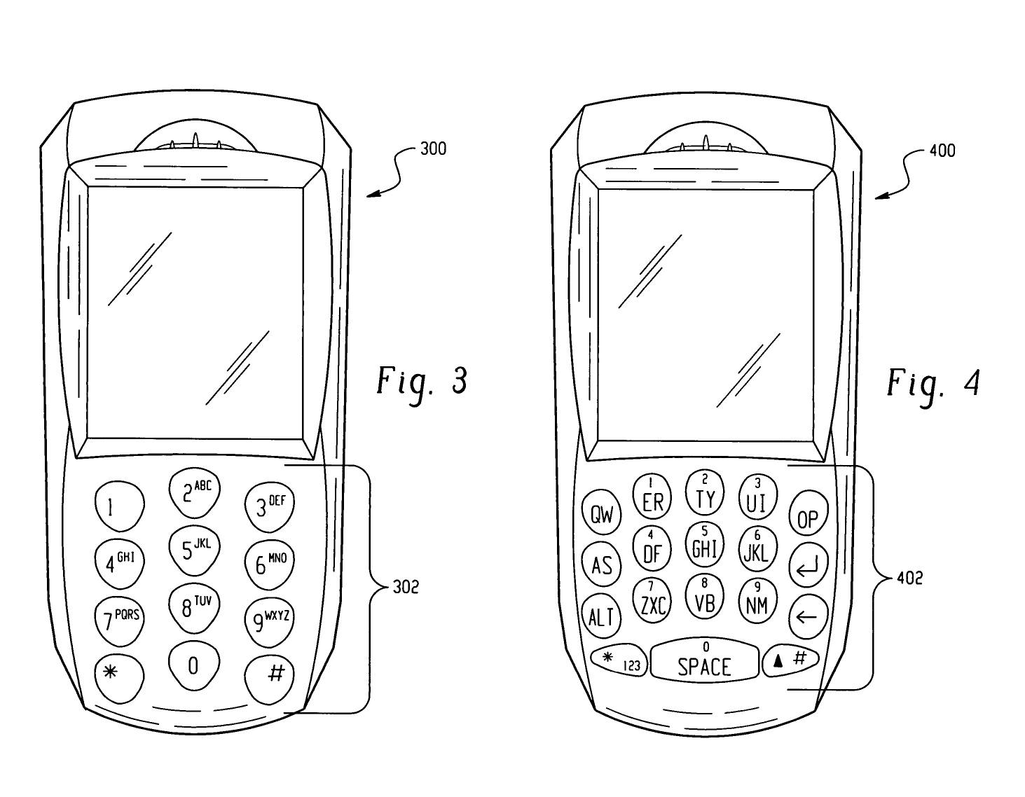

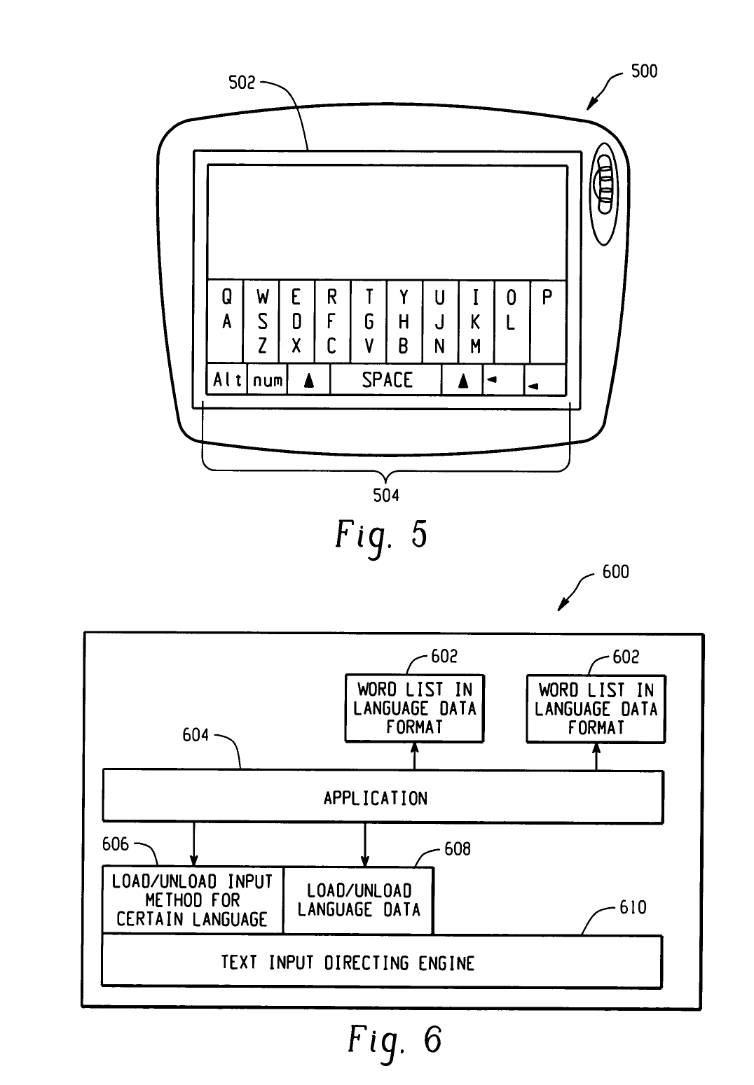

FIGS. 3-5 illustrate example mobile devices having different input devices. FIG. 3 is a top-view of an example mobile device 300 having a telephone-style keypad 302 for entering text. FIG. 4 is a top-view of an example mobile device 400 having a reduced QWERTY-style keyboard 402 for entering text. FIG. 5 is a top-view of an example mobile device 500 having a touch screen 502 for entering text on a virtual keyboard 504. Each of the example input devices shown in FIGS. 3-5 may have a corresponding mapping table 210 within the text input directing engine 204.

FIG. 6 is a block diagram of an example text input directing engine 610 having loading and unloading mechanisms 606, 608. Also illustrated in FIG. 6 are a device application 604 and a plurality of word lists 602. The word lists 602 may include linguistic information or other types of textual data for use by one or more device applications 604, such as a calendar application, an electronic messaging application, an address book application or others. For example, one word list 602 may include address book data, such as email addresses, that may be accessed to input text into fields in an electronic messaging application. Also, as noted above, one or more word lists 602 may be accessed by the active input method 212 to predict a complete word or phrase from a partial input or to perform other input logic functions.

The loading and unloading mechanisms 606, 608 include a first loading and unloading mechanism 606 for loading and deleting input methods 110 to and from device memory and a second loading and unloading mechanism 608 for loading and deleting word lists 602 to and from device memory. Such dynamic loading and unloading of input methods 110 and linguistic data 602 may, for example, be employed to conserve device memory and extend the existing system with new or modified data or logic without significant interfering with the rest of the system.

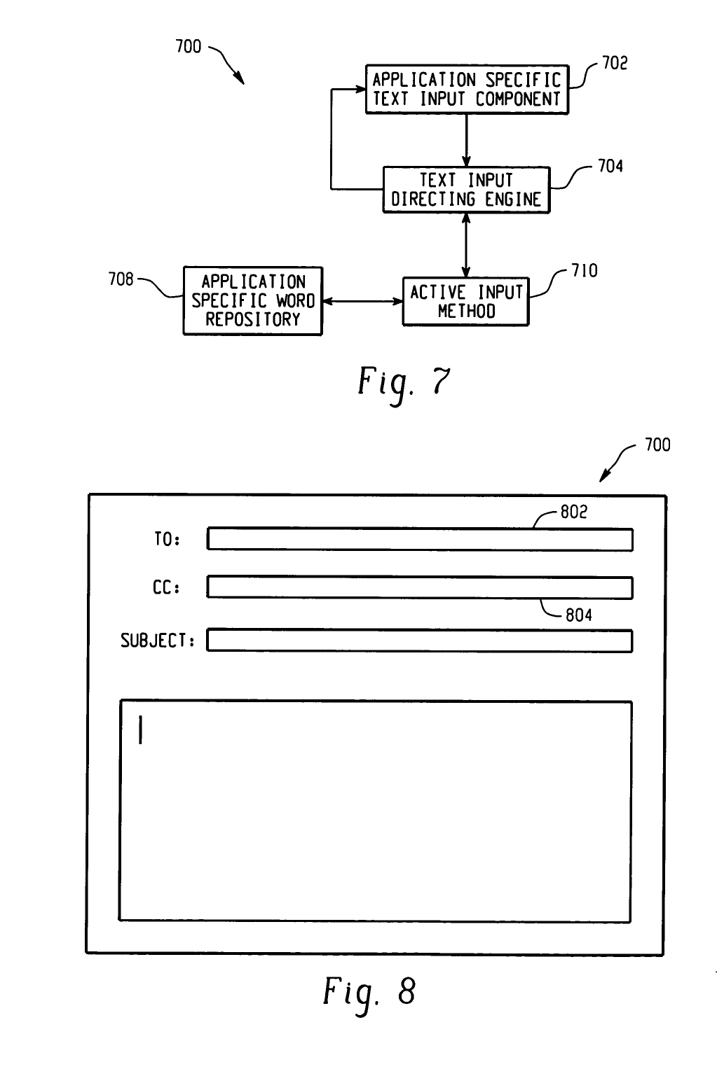

FIG. 7 is a block diagram of an example system 700 for intelligent text input having an application specific text input component 702. An application specific text input component 702 is restricted to certain types of textual input. For example, FIG. 8 illustrates an example graphical user interface (GUI) 800 for an electronic messaging application. The recipient (“TO”) field 802 and the copy (“CC) field 804 in this example electronic messaging GUI are examples of potential application specific text input components 702. For instance, the recipient and copy fields 802, 804 may be restricted to text input in the form of an electronic mail address.

With reference again to FIG. 7, upon receiving an input-restricted text input event from the application specific text input component 702, the text input directing engine 704 converts the text input event into a platform-independent event and associates the platform-independent event with one or more corresponding characters from a language and device specific mapping table, as described above. The text input directing engine 704 then accesses the active input method 710 to apply language specific input logic functions. In addition, data from an application specific word repository may be loaded to the active input method 710 to apply input logic pertaining to the particular application specific text input component 702. For example, an application specific word repository 708 may be defined based on a particular word list 602 that is applicable to the application specific text input component 702. In the example illustrated in FIG. 8, for instance, an application specific word repository 708 defined from an address book word list may be loaded to the active input method 710 when text is entered into the recipient (“TO”) or copy (“CC”) text input components 702. In this manner, the active input method 710 may predict user input in the specific application field with added efficiency and with a higher degree of accuracy.

This written description uses examples to disclose the invention, including the best mode, and also to enable a person skilled in the art to make and use the invention. The patentable scope of the invention may include other examples that occur to those skilled in the art.

It is claimed:

1. An intelligent text input system for a mobile device, comprising:
a plurality of text input components, each text input component being operable to receive a text input event from an input device;
a text input directing engine operable to receive the text input event from each of the plurality of text input components and translate the text input event into a platform-independent event, the platform-independent event including an index value that represents the text input event; and
a plurality of input methods, each input method being operable to receive the platform-independent event from the text input directing engine and translate the platform-independent event into one or more input method specific characters based on the index value;
wherein the one or more input method specific characters is displayed on a graphical user interface by one of the text input components.

2. The system of claim 1, wherein the text input directing engine associates an active input method with one or more text input component.

3. The system of claim 2, wherein the text input directing engine directs the platform-independent event to the active input method.

4. The system of claim 1, wherein the platform-independent event includes event data indicating the state of the input device.

5. The system of claim 1, wherein the platform-independent event includes event data indicating the time at which the text input event was received from the input device.

6. The system of claim 1, wherein the platform-independent event includes event data indicating the number of consecutive occurrences of the text input event.

7. The system of claim 1, wherein each input method translates the platform-independent event into one or more input specific characters of a different language.

8. The system of claim 1, wherein at least one input method applies an input logic function to predict a complete word or phrase from the one or more input method specific characters.

9. The system of claim 8, wherein the one input method accesses a word list associated with one or more of the text input components to predict the complete word or phrase.

10. The system of claim 1, wherein the input device is a telephone-style keypad.

11. The system of claim 1, wherein the input device is a miniature keyboard.

12. The system of claim 1, wherein the input device is a virtual keyboard on a touch screen user interface.

13. The system of claim 1, further comprising:
a loading and unloading mechanism operable to remove one or more of the input methods from the mobile device and add one or more additional input methods to the mobile device.

14. A method of processing a text input event in a mobile device, comprising:
receiving a text input event from an input device;
translating the text input event into a platform-independent event that includes an index value that represents the text input event;
directing the platform-independent event to an active input method selected from a plurality of input methods;
translating the platform-independent event into one or more input method specific characters based on the index value; and
displaying the one or more input method specific characters on a graphical user interface.

15. The method of claim 14, further comprising:
predicting a complete word or phrase from the one or more input method specific characters.

16. A mobile device including an input device, a graphical user interface, and an intelligent text input system, comprising:
a plurality of text input components, each text input component being operable to receive a text input event from the input device;
means for translating the text input event into a platform-independent event, the platform-independent event including an index value that represents the text input event;
means for directing the platform-independent event to an active input method selected from a plurality of input methods;
the plurality of input methods being operable to translate the platform-independent event into one or more input method specific characters; and
means for displaying the one or more input method specific characters on the graphical user interface.

17. The mobile device of claim 16, further comprising:
means for predicting a complete word or phrase from the one or more input method specific characters.
